(19) United States
(12) Patent Application Publication
(10) Pub. No.: US 2015/0180371 A1
(43) Pub. Date: Jun. 25, 2015

(54) ENERGY HARVESTER, AIRCRAFT COMPONENT COMPRISING THE ENERGY HARVESTER AND AN AIRCRAFT COMPRISING THE ENERGY HARVESTER OR THE AIRCRAFT COMPONENT

(71) Applicant: Airbus Defence and Space GmbH, Ottobrunn (DE)

(72) Inventors: Thomas Becker, Osterholz-Scharmbeck (DE); Alexandros Elefsiniotis, Munchen (DE); Ulrich Schmid, Wien (AT)

(21) Appl. No.: 14/574,724

(22) Filed: Dec. 18, 2014

(30) Foreign Application Priority Data
Dec. 20, 2013 (EP) 13 199 099.6

(51) Int. Cl. H02N 1/04; B64D 41/00

(52) U.S. Cl. CPC H02N 1/04; B64D 41/00

(57) ABSTRACT

An energy harvester for an aircraft comprises a first portion, a second portion and an energy storing unit. The first portion includes a charge collecting device having an electrical permittivity different to the one of air. The charge collecting device is configured to be exposed to an air flow. The second portion is configured to be exposed to air and includes a conductive material. The energy storing unit is electrically connected between the first portion and the second portion.

### CROSS-REFERENCE TO RELATED APPLICATION

This application claims priority under 35 U.S.C. §119(a) to European Patent Application No. 13 199 099.6, filed on Dec. 20, 2013, the entire contents of European Patent Application No. 13 199 099.6 are hereby incorporated herein by reference.

### BACKGROUND

1. Field of the Invention

The invention relates to an energy harvester comprising an energy storing unit. Furthermore, the invention relates to an aircraft component comprising the energy harvester. The invention also relates to an aircraft comprising the energy harvester and/or the aircraft component as described before.

2. Background Information

Static electricity is a well-known effect of materials being in contact at first and then got released from each other. This effect can be enhanced by friction, called triboelectricity. A short description is given in Dominic Samson, Energy harvesting in aircraft with special focus on thermal electrics, Dissertation, TU Vienna, 2011: “If two bodies with different permittivities are put in contact, the one having the higher permittivity will be charged positively and the other will be charged negatively after they are separated. The corresponding current is called triboelectric current. If both materials are uncharged perfect conductors, the charge exchange during the contact is counterbalanced by an opposite charge exchange during separation. After the separation both materials are still neutral except if the separation process is very fast compared to the charged transfer. In the case of dielectric materials such as painted aircraft surfaces, the drift velocity of the charges is low in comparison to the separation speed and there is a residual charge.”

An aircraft typically collects charges during cruising by air friction; these charges (which can be harmful for electric devices or communication systems) are being released by so-called static dischargers.

### SUMMARY

An objective of the invention is to provide an improved device for harvesting energy.

An energy harvester for, in particular, an aircraft, according to a disclosed embodiment comprises a first portion, a second portion, and an energy storing unit. The first portion includes a charge collection device having an electrical permittivity different to the one of air and preferably to the one of the impinging particles. The charge collecting device is configured to be exposed to an air flow. The second portion is configured to be exposed to air wherein a second portion includes a conductive material. The energy storing unit is electrically connected between the first portion and the second portion.

Preferably, the charge collecting device is an element of the first portion that is exposed to an air flow. The charge collecting device may be constituted by different shapes. The permittivity of the charge collecting device differs from the one of air such that triboelectric charge is generated in the vicinity of and/or at the charge collecting device due to the air flowing by the charge collecting device. The air flow may be caused by the movement of the charge collecting device, for example when the charge collecting device is part of an aircraft or other vehicles such as high speed trains. In case of an aircraft, the air flow has a high velocity with respect to the charge collecting device. This may lead to the generation of high voltages at the charge collecting device.

The second portion is also configured to be exposed to air. For example, the second portion is arranged in the vicinity of the first portion, in particular to the charge collecting device. The second portion may be arranged in the air flow in which the first portion is arranged. The second portion may include a layer of a conductive material partially or wholly covering the outer surface of the second portion, such that the conductive material is preferably exposed to the air. Alternatively, the second portion is completely made of a conductive material. The conductive material may be metal. The second portion is preferably electrically insulated from the first portion. The conductive material is advantageously highly conductive. The second portion may be considered as a so-called static discharger.

Preferably, the energy storing unit is electrically connected between the charge collecting device and the conductive material of the second portion via conductors such as wires. The energy storing unit is preferably provided for storing the electrical energy generated at the charge collecting device due to tribolelectric friction between the charge collecting device and the air flow.

The energy stored in the energy storing unit may be used to power an electric device of the aircraft, for example a sensor or a sensor node. The energy from the energy storing unit is predominantly consumed in a discontinuous way by the electric device depending on when information or the operation of the electric device is needed. This means for example that, in most cases, consumed energy cannot be correlated with the generation of energy. The energy storing unit might therefore be electrically disconnected from the electric device and only be connected when the electric device needs to operate, for example when the sensors are requested to provide certain parameters.

A preferred effect of the energy harvester may be that the charge generated at the first portion can be directly stored in the energy storing unit. Hence, the efficiency of the energy harvester may be high. Further, the energy harvester can be easily manufactured due the reduced number of parts, preferably reducing production costs.

In a disclosed embodiment, the charge collecting device includes a plate-shaped surface for being exposed to the air flow, wherein preferably the surface is made of a dielectric material. The provision of the plate-shaped surface may provide a large area where friction between the charge collecting device and the air flow occurs for producing triboelectricity. For example, the surface can be placed on the outer skin of an aircraft or other vehicles, such as high speed trains. If the charge collecting device, and in particular the plate-shaped surface that is exposed to the air flow, is made of a dielectric material, the amount of generated electric energy due to triboelectricity can be improved. The dielectric material may a paint of an aircraft.

In a disclosed embodiment, the second portion includes an edge or an apex for locally increasing the electric potential of the second portion. If the electric potential or the electrical field strength of the second portion, in particular the electric potential or the electrical field strength of the conductive material of the second portion, is increased, the second portion may be more prone to release electric energy to air or the air flow. Hence, the energy storing unit may be discharged more readily which in turn may increase the efficiency of the energy storing unit for powering the electric device. Preferably, the conductive material of the second portion exhibit the edge or the apex.

In a disclosed embodiment, the second portion has the shape of a ridge, a cone, or a needle. The mentioned shapes of the second portion, in particular of the conductive material of the second portion, constitute preferred embodiments in order to increase the electric potential. The tip of the cone or the wire can constitute an apex. The ridge may form an edge. The second portion may be incorporated in sections of an aircraft or a vehicle which already have the shape of a ridge, a cone, or a needle and include a conductive material.

In a disclosed embodiment, the energy storing unit comprises a capacitor. A capacitor is a readily available embodiment of an energy storing unit and, therefore, may be cheap and easy to implement. In addition, the energy storing unit may also include an accumulator or a combination of an accumulator and a capacitor. The capacity of the capacitor may be in the range of milliFarad to Farad, for example 100 μF.

The invention also relates to an aircraft component comprising the above mentioned energy harvester. In particular, all the comments and/or the preferred advantages of the energy harvester described above apply for the aircraft component. In a disclosed embodiment, the aircraft component is a section of the fuselage of an aircraft wherein the charge collecting device is arranged on an outer surface of the fuselage.

The aircraft component may also be a wing of an aircraft. Preferably, the charge collecting device includes a surface that is arranged on the outer surface of the fuselage. This has the preferred advantage that the charge collecting device does not significantly increase the aerodynamic drag of the aircraft. For example, the charge collecting device may be an additional component which can be placed on the fuselage. In principal, it can be attached at any position of the aircraft, due to a different generation of friction charge across the aircraft surface (depending for example on the wind speed, the density of particles impinging on the aircraft surface); some location might be preferred. Furthermore, the charge collecting may be arranged such that the collection of tribocharges is done most efficiently and that they are transferred to the capacitor without losses. Other parts or elements of the first portion may be provided inside or in the fuselage.

In a disclosed embodiment, the aircraft component is a section of the fuselage of an aircraft, wherein the charge collecting device is a portion of an outer surface of the fuselage. In this embodiment, a separate charge collecting device is not required. Therefore, the outer surface of the fuselage may be partially or wholly used as a charge collecting device. In particular, portions of the paint of the fuselage may act as a charge collecting device.

In a disclosed embodiment, the energy storing unit is arranged in the fuselage or on the inner surface of the fuselage, wherein preferably the second portion is arranged on the outer surface of the fuselage. The arrangement of the energy storing unit in or inside on the inner surface of the fuselage may reduce the aerodynamic drag in comparison to arranging the energy storing unit on the outer surface of the fuselage. Wires can be used to electrically connect the energy storing unit with the first and/or the second portion.

In a disclosed embodiment, the aircraft component is a rotor blade or fan blade, wherein preferably the charge collecting device is a separate element arranged on the blade. The rotor blade or the fan blade may be blades of a jet engine or a propeller. The charge collecting device may be placed on the blade. This has the preferred advantage that the air flow due to the movement of the blade is very high. Consequently, the generated triboelectric charge may also be high.

In a disclosed embodiment, the energy storing unit and/or all the second portions are also arranged on the blade, in particular the same blade. This may provide a compact design of the energy harvester on a blade as an aircraft component.

The invention also relates to an aircraft comprising the energy harvester as described above and/or the aircraft component as described above. In summary, the invention provides different embodiments for using triboelectricity for energy harvesting purposes. Energy harvesting (or scavenging) denotes all methods to generate electrical energy from ambient energy sources. Ambient energy sources are heat, electromagnetic (for example solar radiation) and kinetic energy (for example mechanical vibrations). A special case is to remote transmission of energy via ultrasound or electromagnetic fields. Energy harvesting is being used for powering or low power sensors or actuators, preferably wirelessly connected to communication networks to make to the complete system fully autonomous. The application areas of triboelectric harvester are, but not limited to, fuselage areas of fixed wing aircraft, rotor blades of rotor crafts and fan blades of engines.

### DESCRIPTION OF THE DRAWINGS

Exemplary embodiments of the invention are further explained in more detail with reference to the enclosed drawings, in which:

FIG. 1 illustrates an example of a side view of an aircraft;

FIG. 2 is a cross-sectional view along line I-I of FIG. 1; and

FIG. 3 illustrates an example of a blade having an energy harvester.

### DETAILED DESCRIPTION OF EMBODIMENTS

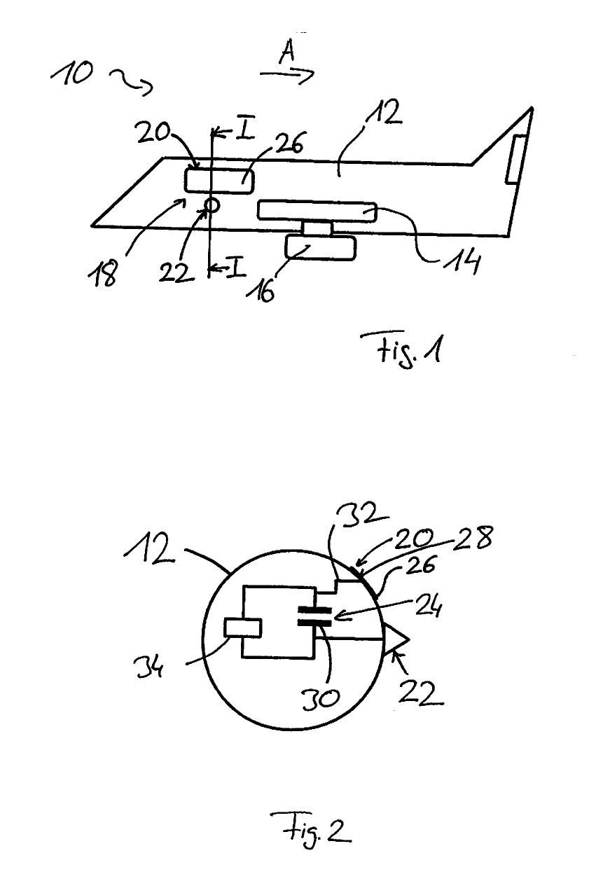

Initially referring to FIG. 1, an aircraft 10 is built up by aircraft components 11 such as a fuselage 12 and a wing 14. A jet engine 16 is mounted to the wing 14. An energy harvester 18 is also provided with the aircraft 10.

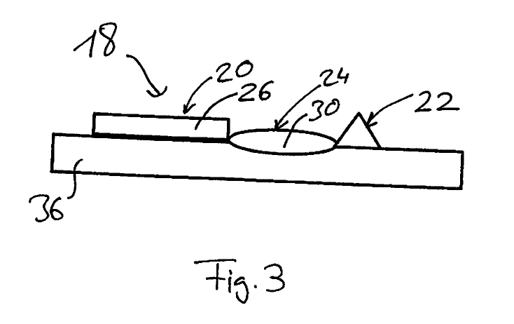

The energy harvester 18 as better seen in FIG. 2 includes a first portion 20, a second portion 22, and a third portion 24. The first portion 20 has a charge collecting device 26 that is arranged on the outer surface of the fuselage 12. The charge collecting device 26 is a plate-shaped member having a surface 28 that is exposed to an air flow A flowing by the aircraft 10.

The second portion 22 is made of metal and has the shape of a cone. The second portion 22 is arranged on the outer surface of the fuselage 12 in the vicinity of the charge collecting device 26 in order to be also exposed to the air flow A. The energy storing unit 24 is arranged inside the fuselage 12 and has a capacitor 30. The capacitor 30 is connected to the charge collecting device 26 and the second portion 22 via wires 32. The energy storing unit 24 is also electrically connected to an electric device 34. The electric device 34 is arranged inside the fuselage 12 in the embodiment shown in FIG. 2. The electric device 34 is a sensor.

A second embodiment of the energy harvester 18 is shown in FIG. 3. The energy harvester 18 is arranged on a blade 36 of the jet engine 16. The first portion 20, the second portion 22 and the energy storing unit 24 are arranged on the blade 36. The charge collecting device 26 is separate from the blade 36 and arranged on it. The energy storing unit 30 and the second portion 22 are also arranged on the blade 36. An example of the function of the energy harvester 18 is as follows.

The air flow A passes by the charge collecting device 26 which generates charges at the charge collecting device 26 due to triboelectricity. The charges are supplies to the capacitor 30 in order to charge it. When the electric device 34 is required to be powered, the electricity stored in the capacitor 34 is used. To discharge the capacitor 34, the second portion 22 interacts with the air flow A. The charge of the capacitor 34 is transferred to the air flow A, most likely on the apex of the second portion 22 since the electrical potential of the second portion 22 is highest there.

What is claimed is:

1. An energy harvester for an aircraft, comprising:
a first portion including a charge collecting device having an electrical permittivity different to that of air, the charge collecting device being configured to be exposed to an air flow;
a second portion configured to be exposed to air, the second portion including a conductive material; and
an energy storing unit electrically connected between the first portion and the second portion.

2. The energy harvester according to claim 1, wherein
the charge collecting device includes a plate-shaped surface that includes a dielectric material and is configured to be exposed to the air flow.

3. The energy harvester according to claim 1, wherein
the second portion includes an edge or an apex configured to locally increase an electric potential of the second portion.

4. The energy harvester according to claim 3, wherein
the second portion has a shape of a ridge, a cone or a needle.

5. The energy harvester according to claim 1, wherein
the energy storing unit comprises a capacitor.

6. An aircraft component comprising an energy harvester according to claim 1.

7. The aircraft component according to claim 6, comprising
a section of a fuselage of the aircraft, with the charge collecting device being disposed on an outer surface of the fuselage.

8. The aircraft component according to claim 6, comprising
a section of a fuselage of the aircraft, with the charge collecting device being configured as a portion of an outer surface of the fuselage.

9. The aircraft component according to claim 6, wherein
the energy storing unit is disposed in the fuselage or on an inner surface of the fuselage, and the second portion is disposed on an outer surface of the fuselage.

10. The aircraft component according to claim 6, wherein
the aircraft component is a blade for a rotor or a fan, and the charge collecting device is a separate element disposed on the blade.

11. The aircraft component according to claim 10, wherein
at least one of the energy storing unit and the second portion are disposed on the blade.

12. An aircraft comprising:
the energy harvester according to claim 1.

13. An aircraft comprising:
the aircraft component according to claim 6.

14. The energy harvester according to claim 2, wherein
the second portion includes an edge or an apex configured to locally increase an electric potential of the second portion.

15. The energy harvester according to claim 14, wherein
the second portion has a shape of a ridge, a cone or a needle.

16. The energy harvester according to claim 2, wherein
the energy storing unit comprises a capacitor.

17. An aircraft component comprising an energy harvester according to claim 2.

18. The aircraft component according to claim 17, comprising
a section of a fuselage of the aircraft, with the charge collecting device being disposed on an outer surface of the fuselage.

19. The aircraft component according to claim 17, comprising
a section of a fuselage of the aircraft, with the charge collecting device being configured as a portion of an outer surface of the fuselage.

20. The aircraft component according to claim 17, wherein
the energy storing unit is disposed in the fuselage or on an inner surface of the fuselage, and the second portion is disposed on an outer surface of the fuselage.
